(19) United States
(12) Patent Application Publication
(10) Pub. No.: US 2026/0095731 A1
(43) Pub. Date: Apr. 2, 2026

(54) SYSTEMS, METHODS AND DEVICES FOR REVERSE VEHICLE OPERATION DETECTION AND WIRELESS PERIPHERAL EQUIPMENT ACTIVATION

(71) Applicant: SCAN˜LINK Holdings Inc., Ancaster (CA)

(72) Inventors: Uwe Dirk Schaible, Ancaster (CA); Jonathan Fava, Ancaster (CA); Steven M. Leatherland, Ancaster (CA); Norman H. von Styp-Rekowski, Ancaster (CA); Gregory E. Mainse, Ancaster (CA)

(21) Appl. No.: 19/345,567

(22) Filed: Sep. 30, 2025

Related U.S. Application Data
(60) Provisional application No. 63/701,153, filed on Sep. 30, 2024.

(51) Int. Cl. H04W 4/40; G06K 7/10; H04W 4/80

(52) U.S. Cl. CPC H04W 4/40; H04W 4/80; G06K 7/10297

(57) ABSTRACT

Systems, methods and devices for reverse operation detection of a vehicle are provided. A system includes a reverse-sensing device, and a receiver. The reverse sensing device is configured to determine that a backup beeper of the vehicle is energized; and, in response to a determination, transmit a broadcast message. The receiver is configured to receive the broadcast message; analyze the broadcast message; and trigger a detection function in an RFID scanning system. A method includes executing via a computer system comprising at least one processor: determining, by a reverse sensing device, that a backup beeper of a vehicle is energized; in response to a determination, transmitting, by the reverse sensing device, a broadcast message; receiving, by a receiver, the broadcast message; analyzing, by the receiver, the broadcast message; and triggering, by the receiver, a detection function in an RFID scanning system.

### TECHNICAL FIELD

The following relates generally to construction safety equipment, and, in particular to systems, methods and devices for detecting the reverse operation of a vehicle and wirelessly activate peripheral equipment for machine-to-human and machine-to-asset collision avoidance applications.

### INTRODUCTION

Construction equipment are heavy-duty vehicles which are able to greatly reduce the time and labour required to carry out large earthwork operations. As such these machines are generally very large, weighing on the order of several tons.

Therefore, there is an inherent danger when mobile construction equipment is operating in close proximity to humans and other valuable assets. Many technologies have been developed to mitigate struck-by accidents on job sites.

One such technology uses backup beepers to alert those nearby that a particular machine may be moving. However, as construction sites can be noisy environments, it may be too late before the beeping is properly heard and reacted to.

Other techniques for mitigating accidents include cameras, radar, or ultrasonic means. However these techniques are also lacking as construction workers may not be able to monitor a video feed or radar screen at all times in order to react, and other machinery or assets are unable to move out of the way unless moved by personnel.

Accordingly, there is a need for improved systems, methods and devices that overcome at least some of the disadvantages of existing techniques.

This background information is provided to reveal information believed by the applicant to be of possible relevance to the present disclosure. No admission is necessarily intended, nor should be construed, that any of the preceding information constitutes prior art against the present disclosure.

### SUMMARY

A system for reverse operation detection of a vehicle is provided. The system includes a reverse-sensing device, and a receiver. The reverse sensing device is configured to determine that a backup beeper of the vehicle is energized; and, in response to a determination, transmit a broadcast message. The receiver is configured to receive the broadcast message; analyze the broadcast message; and trigger a detection function in an RFID scanning system.

In an embodiment, the reverse-sensing device is connected to the vehicle backup beeper via in-line plug.

In an embodiment, to determine that the backup beeper is energized, the reverse-sensing device uses at least one of: an electrical voltage threshold circuit; a current sensing threshold circuit; and an audible sensing threshold circuit.

In an embodiment, to analyze the broadcast message includes at least one of: decode the broadcast message; and determine if an ID of the broadcast message matches a stored ID.

In an embodiment, the broadcast message is at least one of: uniquely coded; and identifiable.

In an embodiment, the broadcast message is transmitted using Bluetooth Low Energy (BLE).

In an embodiment, the receiver is connected to the RFID scanning system via a hardwired in-line plug.

In an embodiment, the receiver is connected to the RFID scanning system via a wireless interface.

In an embodiment, the receiver is internally integrated at the RFID scanning system.

In an embodiment, the receiver is a Bluetooth Low Energy (BLE) receiver.

In an embodiment, to trigger the detection function includes at least one of: activate a relay; send a reverse trigger status to a controller of the RFID scanning system via a digital message; and send a reverse trigger status to a controller of the RFID scanning system via an I/O pin level change.

In an embodiment, the reverse-sensing device is powered by a power source of the vehicle.

In an embodiment, the receiver is powered by a portable scanning device battery.

In an embodiment, the portable scanning device battery is at least one of: primary cell; rechargeable; and solar-powered.

A computer implemented method for reverse operation detection of a vehicle is provided. The method includes executing via a computer system comprising at least one processor: determining, by a reverse sensing device, that a backup beeper of a vehicle is energized; in response to a determination, transmitting, by the reverse sensing device, a broadcast message; receiving, by a receiver, the broadcast message; analyzing, by the receiver, the broadcast message; and triggering, by the receiver, a detection function in an RFID scanning system.

In an embodiment, the reverse-sensing device is connected to the vehicle backup beeper via in-line plug.

In an embodiment, to determine that the backup beeper is energized, the reverse-sensing device uses at least one of: an electrical voltage threshold circuit; a current sensing threshold circuit; and an audible sensing threshold.

In an embodiment, analyzing the broadcast message includes at least one of: decoding the broadcast message; and determining if an ID of the broadcast message matches a stored ID.

In an embodiment, the broadcast message is at least one of: uniquely coded; and identifiable.

In an embodiment, the broadcast message is transmitted using Bluetooth Low Energy (BLE).

In an embodiment, the receiver is connected to the RFID scanning system via a hardwired in-line plug.

In an embodiment, the receiver is connected to the RFID scanning system via a wireless interface.

In an embodiment, the receiver is internally integrated at the RFID scanning system.

In an embodiment, the receiver is a Bluetooth Low Energy (BLE) receiver.

In an embodiment, triggering the detection function includes at least one of: activating a relay; sending a reverse trigger status to a controller of the RFID scanning system via a digital message; and sending a reverse trigger status to a controller of the RFID scanning system via an I/O pin level change.

In an embodiment, the reverse-sensing device is powered by a power source of the vehicle.

In an embodiment, the receiver is powered by a portable scanning device battery.

In an embodiment, the portable scanning device battery is at least one of: primary cell; rechargeable; and solar-powered.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a system for reverse operation detection of a vehicle, according to an embodiment;

FIG. 2 is a flowchart of a method of reverse operation detection of a vehicle, according to an embodiment;

FIG. 3 is a block diagram of an apparatus for reverse operation detection of a vehicle, according to an embodiment;

FIG. 4 is a block diagram of an example electronic device, according to an embodiment;

FIG. 5 is an illustration of a system for reverse operation detection of a vehicle indicating the gear positions in which the system may be configured, according to an embodiment; and

FIG. 6 is a diagram of example cable connections in an RFID scanning system for triggered scanning operation when the vehicle is in reverse; according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

As used herein, the term “about” should be read as including variation from the nominal value, for example, a +/−10% variation from the nominal value. It is to be understood that such a variation is always included in a given value provided herein, whether or not it is specifically referred to.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic controller, a mainframe computer, server, and personal computer, cloud-based program or system, laptop, personal data assistant, cellular telephone, smartphone, or tablet device.

Each program is preferably implemented in a high-level procedural or object-oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present disclosure.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to construction safety equipment, and more particularly to systems, methods and devices for detecting the reverse operation of a vehicle and wirelessly activating peripheral equipment for machine-to-human and machine-to-asset collision avoidance applications.

Active worker detection systems, such as RFID detection systems, have proven to be one of the most reliable technologies to use for ground-worker and valued asset detection in construction, oil and gas, waste, forestry, mining, industrial, and other extreme environment applications. Workers entering a job site are required to wear RFID tag-equipped personal protective equipment (PPE), and valued assets are tagged with RFID markers so that they can be detected by the job site's mobile equipment-mounted RFID scanning antennas.

The main components of an RFID scanning system for machine-to-human and machine-to-asset collision avoidance applications are generally an antenna, a processing/computing component, a display, an external alarm, and a mounting bracket.

Housed in a rugged and sealed weatherproof enclosure, the beam-shaping antenna monitors the area behind the vehicle. The antenna system is designed to detect associated safety apparel and uses a reliable wireless link to relay its information to a display unit located near the equipment operator. The system may also be able to capture and store data.

The rugged and compact display unit uses both a bright visual display (LEDs) and an audible alarm (adjustable volume) to alert the equipment operator when safety apparel is detected. The display unit is linked wirelessly to the antenna and regular self-diagnostic checks ensure that the link to the antenna is present and the system is functioning normally.

An external beeper alarm is an essential accessory, mounted on the outside of the vehicle (e.g., mobile equipment) to allow groundworkers in the vicinity to hear a staccato alert warning on the detection of a tagged worker in an area of interest (e.g., a danger zone).

An adjustable antenna mounting bracket has mounting holes on either side for the external beeper alarm. The washer is simply unthreaded from the alarm, the alarm is inserted into the mounting hole and the washer is threaded back on.

Company-owned mobile equipment is usually outfitted with RFID scanning antennas at the original equipment manufacturer (OEM) factory or as an after-market product before the start of the job. Contractors who bid on the job and temporarily bring their own specific mobile equipment on-site to perform certain tasks are required to install RFID scanning antennas on their equipment and to ensure that their workers wear RFID tag-equipped PPE.

In many cases, the mobile equipment on the job site is rented and not owned by either the job site owner, contractor, or subcontractor. RFID scanning antennas must be installed and then removed before the equipment returns to the rental company. In such cases, it is of significant benefit to quickly and temporarily attach the RFID scanning system to the equipment versus a permanent/invasive hard wire installation on the machine as permanent installations can take several hours to install (1.5-4 hours) and remove again (1-2 hours).

Using a battery-operated version of the RFID scanning system would thus allow for a much quicker installation and removal process.

Such an antenna may be paired with an in-cab display that is equipped with an accessory or ‘cigarette lighter’ plug at its power cable end. System installation and removal can generally be performed in less than five minutes, which allows for a very efficient and cost-effective means to provide temporary machine-to-human and machine-to-asset detection on mobile equipment entering and leaving a protected job site.

Detection functions that are always on may cause nuisance alarms when the mobile equipment is stationary or moving forward. An ideal solution would only enable detection when the equipment is moving (or about to move) in reverse. This also provides an additional benefit to a temporarily mounted solution operating on batteries by saving power when detection is not enabled.

In a hardwired, non-battery-operated RFID scanning system, the vehicle reverse trigger is typically derived from a wire connected to the power line of the backup beeper, or from a wire connected to the reverse solenoid or transmission switch.

Reverse vehicle detection for the wireless battery-operated RFID scanning system can be implemented using accelerometer circuitry, GPS, mechanical tilt, vibration, acoustic, and other methods. The disadvantage of such methods is that they require the vehicle to be set in motion, which increases the initial dead time of the detection response. Acoustic and vibration sensing are also prone to signal interference from other sources.

What is needed is a device that is connected in-line, or integral, with the mobile equipment backup beeper that wirelessly transmits the state of activation of the backup beeper to the RFID scanning system. Activation of the backup beeper indicates the intent for the equipment to move backward, thereby providing the earliest possible trigger mechanism for the enable input of a detection system. Such a device can be used to not only trigger the detection function of an RFID scanning system but also trigger the detection function of many other types of detection systems, including radar, ultrasonic, camera, and LIDAR. Though intended primarily for impending reverse operation sensing, this wireless reverse sensing transmitter can be used in any application where an electrical state change is required to be detected and transmitted as an input activation to a peripheral device.

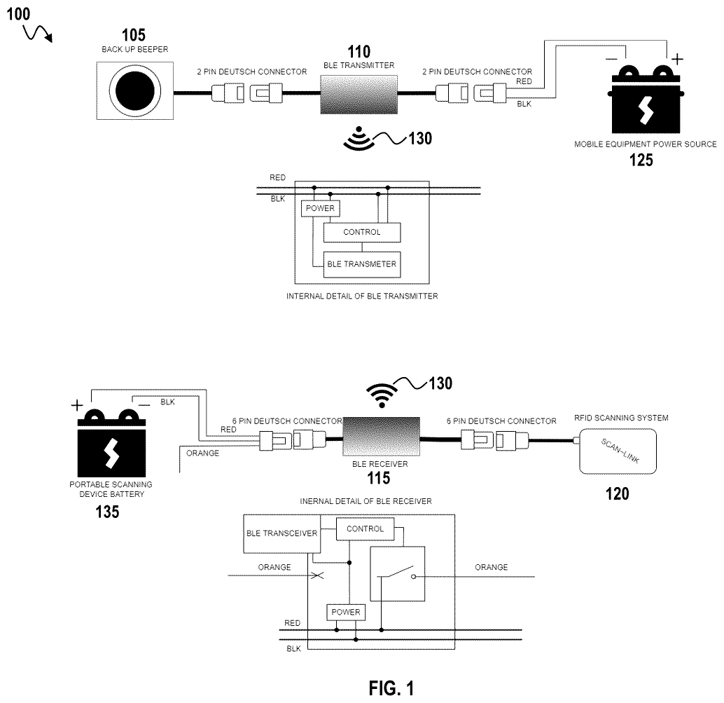

Referring now to FIG. 1, shown therein is a schematic diagram of a system 100 for reverse operation detection of a vehicle (e.g., mobile equipment), according to an embodiment.

The detection of a vehicle that is about to set into motion in reverse may be accomplished by detecting the electrical signal from the vehicle's reverse signal alarm (backup beeper 105).

Such backup beepers may be mandated by organizations such as the Occupational Safety and Health Administration (OSHA).

In the system 100, a reverse-sensing device (transmitter) 110 is connected to the vehicle backup beeper 105 to determine when the backup beeper 105 is energized.

In an embodiment, the reverse-sensing device 110 is connected to the vehicle backup beeper 105 via in-line plug.

In an embodiment, the reverse sensing device 110 employs an electrical voltage threshold circuit to determine when the backup beeper 105 is energized.

In an embodiment, the reverse sensing device 110 employs a current sensor to determine when the backup beeper 105 is energized.

In an embodiment, the reverse sensing device 110 employs an audible sensor, such as a microphone with frequency band filtering, to determine when the backup beeper 105 is energized.

In response to sensing the energization of the backup beeper 105, the reverse sensing device 110 wirelessly transmits a uniquely coded and identifiable broadcast message 130.

In an embodiment, the broadcast message 130 is transmitted using Bluetooth Low Energy (BLE).

In various embodiments, the broadcast message 130 may be transmitted using other methods of wireless transmission or RF communication.

The broadcasted message 130 is received by a nearby receiver 115 connected to the battery-operated RFID scanning system 120, which analyzes the message 130.

In an embodiment, the receiver 115 is a Bluetooth Low Energy (BLE) receiver.

Those having skill in the art will appreciate that Bluetooth Low Energy is just one protocol that may be used, and that there are several other protocols or RF transceivers which may also be used.

In an embodiment, the receiver 115 is connected to the battery-operated RFID scanning system 120 via a hardwired in-line plug.

In an embodiment, the receiver 115 is connected to the RFID scanning system 120 via a wireless interface.

In an embodiment, the receiver 115 is internally integrated/housed at the RFID scanning system 120.

In an embodiment, analyzing the message 130 includes at least one of decoding the message 130 and, determining if an ID of the message 130 matches a stored ID.

The receiver 115 then triggers the ‘reverse input detection’ function of an antenna of the RFID scanning system 120

In various embodiments, the RFID scanning system 120 may be activated to find wearable safety devices, marker tags, waypoint IDs, or the like.

In various embodiments, the receiver 115 may also be used to activate other warning signals, LEDs, audible alarms, transmitters, or the like.

In an embodiment, the receiver 115 triggers the detection (reverse input detection) function by at least one of activating a relay, sending a reverse trigger status to a controller of the RFID scanning system 120 via digital message, sending a reverse trigger status to a controller of the RFID scanning system 120 via an I/O pin level change.

In various embodiments, a digital message may include an RS-485 message to the RFID scanning system 120 containing the status of the reverse operation. The digital message could also be sent wirelessly using another means of wireless communication (such as an 802.15.4 compliant transceiver module) to the RFID scanning system 120 or peripheral equipment.

In various embodiments, an I/O pin level change may include a voltage threshold with a voltage ≤1V as being considered as no reverse (i.e., reverse inactive) operation, and a voltage level ≥4.6V as reverse operation active.

In an embodiment, the reverse-sensing device 110 is powered by a power source 125 of the vehicle.

In an embodiment, 2-pin Deutsch connectors are used to connect the reverse-sensing device 110 to the backup beeper 105 and the power source 125.

In an embodiment, the receiver 115 is powered by a portable scanning device battery 135.

In an embodiment, the portable scanning device battery 135 is at least one of primary cell, rechargeable, and/or solar-powered.

In an embodiment, 6-pin Deutsch connectors are used to connect the receiver 115 to the portable scanning device battery 135 and the RFID scanning system 120.

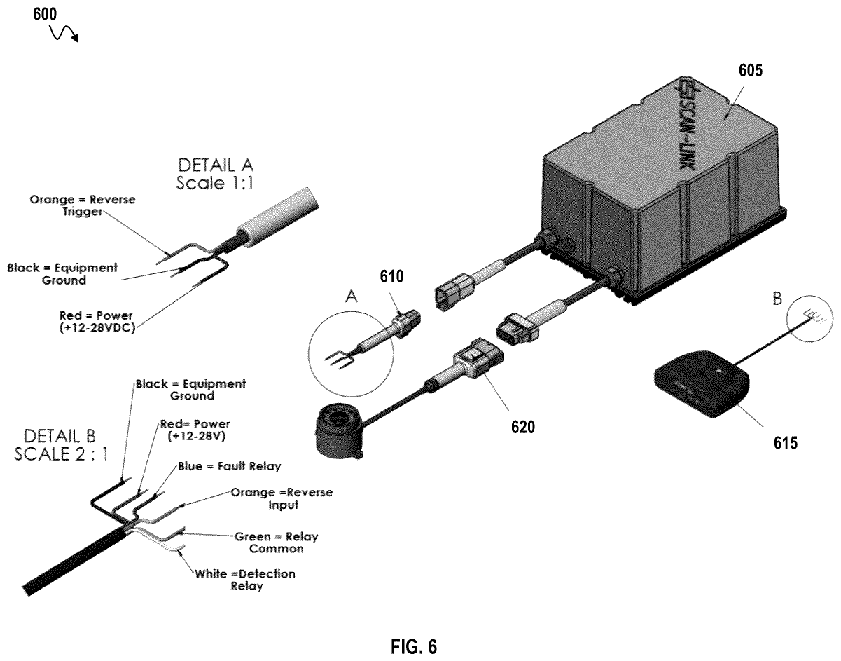

FIG. 6 depicts an example diagram 600 of the cable connections for a reverse operation enabled RFID detection system of a vehicle (e.g., the system 120 of FIG. 1), according to an embodiment.

In diagram 600, the RFID scanning antenna 605 is both powered and scanning enabled through its connection to cable harness 610 via Deutsch connector.

The cable harness 610 is the power and signal harness used to supply power and reverse status to the RFID scanning antenna 605. The 3-wire version depicted in “Detail A” may also be replaced with a 6-wire version that includes the transmit, receive, and common signal conductors for an RS-485 digital message interface.

In-cab display unit 615 is used for warning the vehicle operator. “Detail B” depicts the cable connections which are used to supply power and reverse status to the in-cab display unit 615, as well as the detection and fault relay output signals from the in-cab display unit 615.

External alarm 620 is activated by the RFID scanning system 605 to warn nearby personnel on detection.

In various embodiments, installation of the battery-powered system 100 takes about 10-15 minutes, with removal taking about 5 minutes.

In various embodiments, a completely non-invasive mounting procedure is used, first attaching the scanning antenna to the desired location on the mobile equipment's metal body using magnets.

Next the Deutsch connector is unplugged from the backup beeper alarm and plugged into the wireless reverse trigger transmitter in-line.

Then the indicator is attached using Velcro and plugged into the accessories port or “cigarette lighter.”

To uninstall, the process includes pulling the magnet-mounted scanning antenna off, unplugging the wireless reverse trigger transmitter, plugging the backup beeper alarm Deutsch connector back into the backup beeper, then pulling the display off the Velcro, and unplugging it.

Advantageously, the system 100 may be implemented on either owned or rented equipment, thereby allowing a company to use the disclosed system in projects where rented equipment is being used.

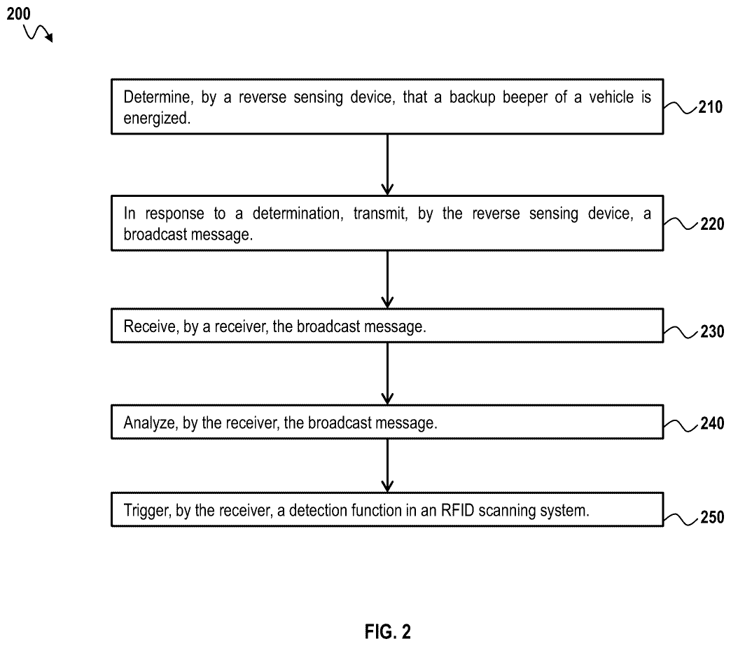

Referring now to FIG. 2, illustrated therein is a flowchart of a method 200 for wireless vehicle reverse sensing, according to an embodiment.

The method 200 may be encoded as computer-executable instructions which, when executed by one or more processors, cause the computer to perform the method.

The detection of a vehicle that is about to set into motion in reverse may be accomplished by detecting the electrical signal from the vehicle's reverse signal alarm (backup beeper).

Such backup beepers may be mandated by organizations such as the Occupational Safety and Health Administration (OSHA).

At 210, the method 200 includes determining, by a reverse sensing device, that a backup beeper of a vehicle is energized.

In an embodiment, the reverse-sensing device is connected to the vehicle backup beeper via in-line plug.

In an embodiment, the reverse sensing device employs an electrical voltage threshold circuit to determine when the backup beeper is energized.

In an embodiment, the reverse sensing device employs a current sensor to determine when the backup beeper is energized.

In an embodiment, the reverse sensing device employs an audible sensor, such as a microphone with frequency band filtering, to determine when the backup beeper is energized.

At 220, the method 200 further includes, in response to a determination, transmitting (e.g., wirelessly), by the reverse sensing device, a broadcast message.

At 230, the method 200 further includes receiving, by a receiver, the broadcast message.

In an embodiment, the receiver is connected to the battery-operated RFID scanning system via a hardwired in-line plug.

In an embodiment, the receiver is connected to the RFID scanning system via a wireless interface.

In an embodiment, the receiver is internally integrated/housed at the RFID scanning system.

At 240, the method 200 further includes analyzing, by the receiver, the broadcast message.

In an embodiment, analyzing the broadcast message includes at least one of decoding the broadcast message and, determining if an ID of the broadcast message matches a stored ID.

At 250, the method 200 further includes triggering, by the receiver relay (e.g., by activation of a relay) or digital message via hardwire or wireless communications means, the detection function in an RFID scanning system.

In an embodiment, the receiver activates a relay to trigger the detection function of the RFID scanning system.

In an embodiment, the receiver sends a reverse trigger status to a controller of the RFID scanning system via hardwired or wireless digital message or I/O pin level change.

In an embodiment, the reverse-sensing device 110 is powered by a power source of the vehicle.

In an embodiment, the receiver is powered by a portable scanning device battery.

In an embodiment, the portable scanning device battery is at least one of primary cell, rechargeable, and/or solar-powered.

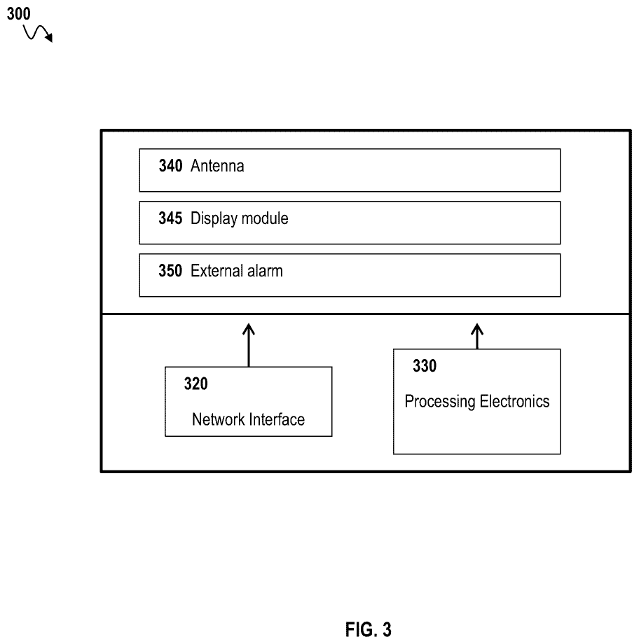

Referring now to FIG. 3, shown therein is an apparatus 300 for wireless vehicle reverse sensing, according to an embodiment.

In various embodiments, the apparatus 300 may be located at a vehicle (e.g., a mobile equipment).

The apparatus 300 includes a network interface 320 and processing electronics 330.

The processing electronics 330 may include a computer processer executing program instructions stored in memory, or other electronics components such as digital circuitry, including for example FPGAs and ASICs.

The network interface 320 may include an optical communication interface or radio communication interface, such as a transmitter and receiver, capable of, for example, sending and receiving the message 130 of FIG. 1.

The apparatus 300 may include several functional components, each of which is partially or fully implemented using the underlying network interface 320 and processing electronics 330. For example, in various embodiments, the apparatus 300 may further include one or more of a power source, and a RFID scanning system.

The apparatus 300 further includes an antenna 340.

In an embodiment, the antenna 340 is housed in a rugged and/or sealed weatherproof enclosure.

In an embodiment, the antenna 340 is a beam-shaping antenna.

In an embodiment, the antenna 340 monitors an area of interest.

The apparatus 300 further includes a display module 345.

The display unit 345 is configured to alert an operator of a vehicle in response to receiving the detection 110.

In an embodiment, the display unit 345 is a rugged and compact unit.

In an embodiment, the display unit 345 uses at least one of a bright visual display (e.g., LEDs), and an audible alarm (e.g., adjustable volume) to alert the operator in response to receiving the detection information from the antenna 340.

In an embodiment, the display unit 345 includes a wireless link to the antenna 340.

In an embodiment, the display unit 345 performs regular self-diagnostic checks to ensure that the wireless link is present and functioning normally.

The apparatus 300 further includes an external alarm 350.

The external alarm 350 is configured to provide an audible alert in response to receiving the detection information from the antenna 340.

In an embodiment, the external alarm 350 is mounted at a vehicle to allow groundworkers in the vicinity to hear the audible alert (e.g., a staccato alert) indicating the detection of a wearable safety device within an area of interest.

In an embodiment, the antenna 340 uses a wireless link to relay detection information to the display unit 345 and the external alarm 350.

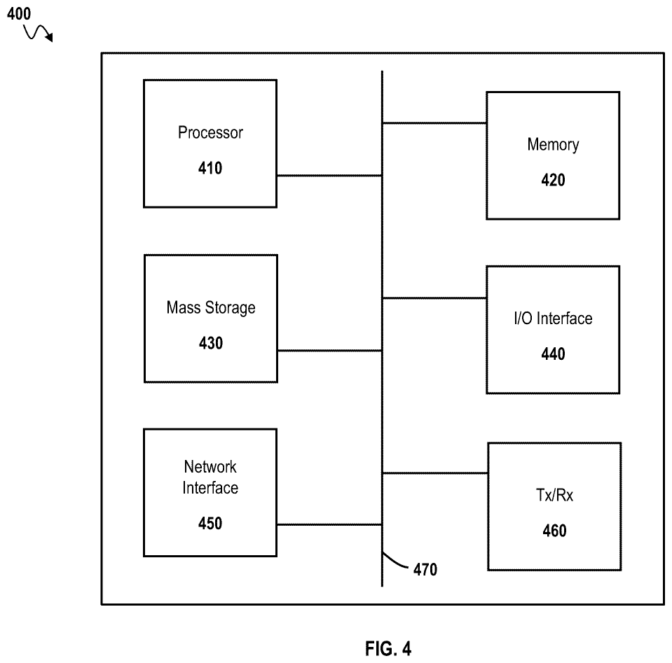

Referring now to FIG. 4, shown therein is a schematic diagram of an electronic device 400 that may perform any or all of operations of the above methods and features explicitly or implicitly described herein, according to different embodiments of the present disclosure. For example, a computer equipped with network function may be configured as electronic device 400. Furthermore, the electronic device 400 may be used to implement the apparatus 300 of FIG. 3, for example.

As shown, the device includes a processor 410, such as a Central Processing Unit (CPU) or specialized processors such as a Graphics Processing Unit (GPU) or other such processor unit, memory 420, non-transitory mass storage 430, I/O interface 440, network interface 450, and a transceiver 460, all of which are communicatively coupled via bi-directional bus 470.

According to certain embodiments, any or all of the depicted elements may be utilized, or only a subset of the elements. Further, the device 400 may contain multiple instances of certain elements, such as multiple processors, memories, or transceivers.

Also, elements of the hardware device may be directly coupled to other elements without the bi-directional bus. Additionally, or alternatively to a processor and memory, other electronics, such as integrated circuits, may be employed for performing the required logical operations.

The memory 420 may include any type of non-transitory memory such as static random access memory (SRAM), dynamic random access memory (DRAM), synchronous DRAM (SDRAM), read-only memory (ROM), any combination of such, or the like.

The mass storage element 430 may include any type of non-transitory storage device, such as a solid state drive, hard disk drive, a magnetic disk drive, an optical disk drive, USB drive, or any computer program product configured to store data and machine executable program code.

According to certain embodiments, the memory 420 or mass storage 430 may have recorded thereon statements and instructions executable by the processor 410 for performing any of the aforementioned method operations described above.

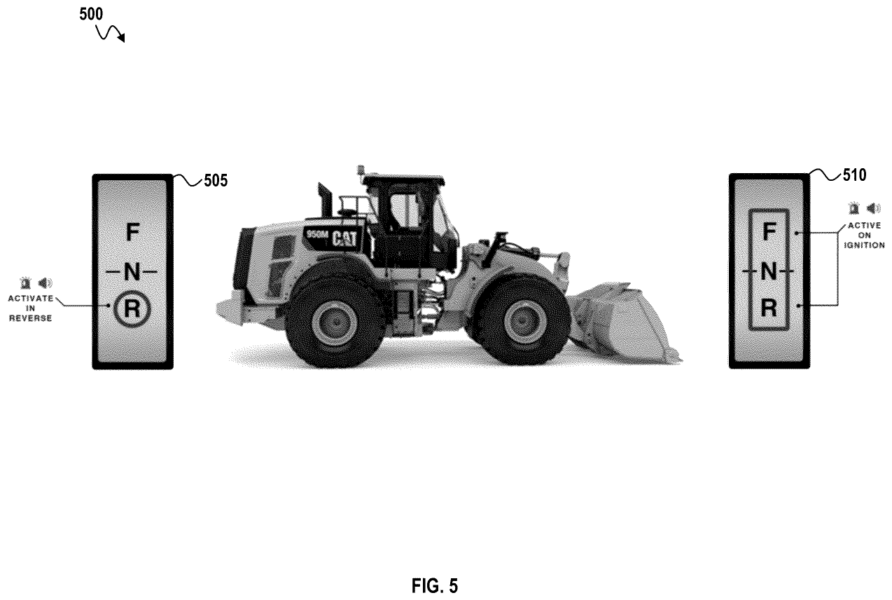

Referring now to FIG. 5, shown therein is an illustration of a system 500 for reverse operation detection of a vehicle (e.g., based on the system 100 of FIG. 1) indicating the gear positions in which the system 500 may be configured, according to an embodiment.

At 505, it is indicated that a system for reverse operation detection of a vehicle may be activated in the reverse gear position.

At 510, it is indicated that, on ignition, the system for reverse operation detection of a vehicle would be active.

Advantageously, this default setting of the system being active on ignition would allow a vehicle operator to immediately realize if a human or asset were close by.

While the above description provides examples of one or more apparatuses, methods, or systems, it will be appreciated that other apparatuses, methods, or systems may be within the scope of the claims as interpreted by one of skill in the art. Elements of each embodiment may be incorporated into other embodiments, for example, configurations discussed in relation to one embodiment, may be applied to other embodiments disclosed herein. Further, it is evident that various modifications and combinations can be made without departing from the invention. The specification and drawings are, accordingly, to be regarded simply as an illustration of the invention as defined by the claims, and are contemplated to cover any and all modifications, variations, combinations or equivalents that fall within the scope of the present disclosure.

1. A system for reverse operation detection of a vehicle, the system comprising:
a reverse-sensing device configured to:
determine that a backup beeper of the vehicle is energized;
in response to a determination, transmit a broadcast message;
a receiver configured to:
receive the broadcast message;
analyze the broadcast message; and
trigger a detection function in an RFID scanning system.

2. The system of claim 1, wherein the reverse-sensing device is connected to the vehicle backup beeper via in-line plug.

3. The system of claim 1, wherein to determine that the backup beeper is energized, the reverse-sensing device uses at least one of: an electrical voltage threshold circuit; a current sensing threshold circuit; and an audible sensing threshold circuit.

4. The system of claim 1, wherein to analyze the broadcast message includes at least one of: decode the broadcast message; and determine if an ID of the broadcast message matches a stored ID.

5. The system of claim 1, wherein the broadcast message is at least one of: uniquely coded; and identifiable.

6. The system of claim 1, wherein the broadcast message is transmitted using Bluetooth Low Energy (BLE).

7. The system of claim 1, wherein the receiver is at least one of: connected to the RFID scanning system via a hardwired in-line plug; connected to the RFID scanning system via a wireless interface; internally integrated at the RFID scanning system; and a Bluetooth Low Energy (BLE) receiver.

8. The system of claim 1, wherein to trigger the detection function includes at least one of: activate a relay; send a reverse trigger status to a controller of the RFID scanning system via a digital message; and send a reverse trigger status to a controller of the RFID scanning system via an I/O pin level change.

9. The system of claim 1, wherein the reverse-sensing device is powered by a power source of the vehicle.

10. The system of claim 1, wherein the receiver is powered by a portable scanning device battery.

11. The system of claim 10, wherein the portable scanning device battery is at least one of: primary cell; rechargeable; and solar-powered.

12. A computer implemented method for reverse operation detection of a vehicle, the method comprising executing via a computer system comprising at least one processor:
determining, by a reverse sensing device, that a backup beeper of a vehicle is energized;
in response to a determination, transmitting, by the reverse sensing device, a broadcast message;
receiving, by a receiver, the broadcast message;
analyzing, by the receiver, the broadcast message; and
triggering, by the receiver, a detection function in an RFID scanning system.

13. The method of claim 12, wherein the reverse-sensing device is connected to the vehicle backup beeper via in-line plug.

14. The method of claim 12, wherein to determine that the backup beeper is energized, the reverse-sensing device uses at least one of: an electrical voltage threshold circuit; a current sensing threshold circuit; and an audible sensing threshold.

15. The method of claim 12, wherein analyzing the broadcast message includes at least one of: decoding the broadcast message; and determining if an ID of the broadcast message matches a stored ID.

16. The method of claim 12, wherein the broadcast message is at least one of: uniquely coded; and identifiable.

17. The method of claim 12, wherein the broadcast message is transmitted using Bluetooth Low Energy (BLE).

18. The method of claim 12, wherein the receiver is at least one of: connected to the RFID scanning system via a hardwired in-line plug; connected to the RFID scanning system via a wireless interface; internally integrated at the RFID scanning system; and a Bluetooth Low Energy (BLE) receiver.

19. The method of claim 12, wherein triggering the detection function includes at least one of: activating a relay; sending a reverse trigger status to a controller of the RFID scanning system via a digital message; and sending a reverse trigger status to a controller of the RFID scanning system via an I/O pin level change.

20. The method of claim 12, wherein the reverse-sensing device is powered by a power source of the vehicle.
